(19) United States
(12) Patent Application Publication
(10) Pub. No.: US 2026/0193401 A1
(43) Pub. Date: Jul. 9, 2026

(54) MULTI-COMPONENT RESIN SYSTEM COMPRISING AN ISOCYANATE MIXTURE

(71) Applicant: Hilti Aktiengesellschaft, Schaan (LI)

(72) Inventors: Christian Plenk, Kaufering (DE); Memet-Emin Kumru, Augsburg (DE); Thomas Bürgel, Landsberg (DE)

(73) Assignee: Hilti Aktiengesellschaft, Schaan (LI)

(21) Appl. No.: 19/131,560

(22) PCT Filed: Nov. 9, 2023
(86) PCT No.: PCT/EP2023/081267

§ 371 Date: May 21, 2025

(30) Foreign Application Priority Data
Nov. 24, 2022 (EP) 22209343.7

(51) Int. Cl. C08G 18/38; C08G 18/32; C08G 18/72; C08G 18/73; C08G 18/75; C09D 175/02; E04B 1/38; E04B 1/41

(52) U.S. Cl. CPC C08G 18/3865; C08G 18/324; C08G 18/722; C08G 18/73; C08G 18/755; C09D 175/02; E04B 1/383; E04B 1/4157

(57) ABSTRACT

A multi-component resin system has (i) at least one isocyanate component (A) having at least one non-cyclic aliphatic polyisocyanate and at least one cycloaliphatic polyisocyanate having an average NCO functionality of about 2 or greater and (ii) at least one amine component (B) having at least one organic amine reactive towards isocyanate groups having an average NH functionality of about 2 or greater. Employing the cycloaliphatic polyisocyanate in addition to the non-cyclic aliphatic polyisocyanate has the effect that at a substrate temperature significantly above 23° C., a higher bond stress is achieved than is the case with a comparative multi-component resin system in which the cycloaliphatic polyisocyanate is absent. Such a multi-component resin system finds application for the chemical fastening of construction elements in depressions, or as an adhesive.

The present invention relates to a multi-component resin system comprising (i) at least one isocyanate component (A) comprising at least one non-cyclic aliphatic polyisocyanate and at least one cycloaliphatic polyisocyanate having an average NCO functionality of about 2 or greater and (ii) at least one amine component (B) comprising at least one organic amine reactive towards isocyanate groups having an average NH functionality of about 2 or greater. The use of the cycloaliphatic polyisocyanate in addition to the non-cyclic aliphatic polyisocyanate has the effect that at a substrate temperature significantly above 23° C., in particular at around 100° C., a higher bond stress is achieved than is the case with a comparative multi-component resin system in which the cycloaliphatic polyisocyanate is absent (which comprises, for example, only a non-cyclic aliphatic polyisocyanate). The present invention further relates to the use of such a multi-component resin system for the chemical fastening of construction elements in depressions, in particular holes (for example boreholes) or gaps, and the use thereof as an adhesive.

In the construction industry, resin systems are used for the chemical fastening of construction elements, such as anchor rods, reinforcing bars and screws, in boreholes or gaps of buildings. Such resin systems are also referred to as “chemical anchors”, wherein a chemical anchor is typically a mortar composition, i.e., contains a filler in addition to the components of the resin system forming the resin. Likewise, resin systems play an important role in the use as an adhesive.

These resin systems can be present as a unitary resin composition or as a system made up of a plurality components. Usually, resin systems are commercially available as a multi-component resin system. A multi-component resin system can be understood to mean a resin system having a plurality of components, typically two components (two-component system), having (i) at least one component (A) comprising a curable compound and (ii) at least one component (B) comprising a curing agent for said curable compound, and optionally further separate components. The components are in separate containers so that they do not come into contact with one another during storage and cannot react with one another before use. For the intended use of a multi-component resin system, the components (A) and (B), and in some cases further components, are mixed at the desired site of use so that the curing reaction can take place there.

Cartridges, for example made of plastics, ceramic or glass, in which the components are arranged separately from one another by destructible delimiting walls or integrated separate destructible containers, for example as cartridges nested inside one another, preferably two-chamber cartridges, are suitable for storing said components before use. However, in particular multi-component or preferably two-component cartridges, the chambers of which separately contain components (A) and (B) of a multi-component resin system, are typical for storing said components before use. By destroying the delimitations in the cartridges or by squeezing the cartridges through, for example, a static mixer, the two or more components are mixed. As a result, a curing reaction, i.e., polymerization, is initiated and the resin is cured.

In a multi-component resin system, other customary constituents, for example fillers, additives, accelerators, inhibitors, rheological additives, solvents and reactive diluents, can be contained in one or both components (A) and/or (B), and optionally further components. Multi-component resin systems may in some cases also contain fillers, which can contribute to solidification, even by hydraulic setting, as in the case of cement. In particular, multi-component resin systems based on methacrylate resins and based on epoxy resins are known as chemical anchors. However, these resin systems are often only suitable to a limited extent for use at very high temperatures, in particular at temperatures above 80° C. or even 100° C. or higher. For applications in hot regions or in hot ambient temperatures, for example due to direct sunlight, there is therefore a need for more suitable resin systems. Moreover, a sufficient bond stress of chemical anchors at high temperatures is also important in the event of fire in order to extend the period of time during which a chemical anchor still holds despite the high temperatures caused by the fire (and thus, for example, delays the falling of building parts fastened with the chemical anchor or the collapse of a burning building, in the best case until all persons have escaped from the burning building).

In addition, multi-component resin systems based on methacrylate resins tend not to be suitable as adhesives (e.g., for the adhesive bonding of two surfaces).

In addition to the development and improvement of existing multi-component resin systems, resin systems other than the aforementioned resin systems are thus increasingly also being investigated for their suitability as a basis for chemical anchors. Polyurethanes and polyureas, i.e., polymers based on polyisocyanate, are increasingly being considered as resins for chemical anchors.

For example, EP 3 447 078 A1 describes a chemical anchor prepared from a multi-component composition comprising a polyisocyanate component (A) and a polyaspartic ester component (B). When the two components are mixed, polyurea is formed in a polyaddition reaction, which forms the resin as binder of the mortar composition.

Multi-component systems based on polyurethanes are known from DE 10 2008 018 861 A1 which are formed from one or more diisocyanates and/or polyisocyanates, one or more diols and/or polyols or diamines and/or polyamines, or one or more difunctional and/or polyfunctional amino, hydroxy and/or amino and hydroxy compounds.

The object of the present invention is to provide a multi-component resin system based on polyisocyanate which is suitable for fastening purposes. A mortar composition prepared from such a multi-component resin system should be usable at higher temperatures compared to conventional chemical anchors, also compared to conventional isocyanate-based chemical anchors, advantageously with a comparably high pull-out strength under reference conditions. In particular, it is an object of the present invention to provide a mortar composition based on polyisocyanates which exhibits improved pull-out strength (bond stress) at high temperatures, in particular at temperatures of about 80° C. or higher, or even of about 100° C. or higher.

This object is achieved by the multi-component resin system specified in the claims and the use thereof described herein.

Preferred embodiments are provided in the dependent claims, which may optionally be combined with one another.

The invention relates to a multi-component resin system comprising:
a. an isocyanate component (A), and
b. an amine component (B) comprising at least one organic amine reactive towards isocyanate groups and having an average NH functionality of about 2 or greater.

The isocyanate component (A) comprises at least one non-cyclic aliphatic polyisocyanate (A1) having an average NCO functionality of about 2 or greater and at least one cycloaliphatic polyisocyanate (A2) having an average NCO functionality of about 2 or greater. The quantitative ratio (A1:A2) (w/w) is from 1:0.1 to 1:10, preferably from 1:0.5 to 1:5, more preferably from 1:0.5 to 1:1.5.

The invention also provides a resin composition prepared by mixing the isocyanate component (A) and the amine component (B) of the multi-component resin system according to the invention.

The invention also relates to the use of a resin composition prepared from a multi-component resin system according to the invention as an adhesive, in particular as an adhesive for fastening construction elements to a building or to a part of a building.

The invention also relates to the use of a resin composition prepared from a multi-component resin system according to the invention for the chemical fastening of construction elements in depressions, in particular in (bore)holes or gaps.

It is typically used at a substrate temperature of −10° C. to 120° C., preferably from 0° C. to 110° C., more preferably from 10° C. to 105° C., even more preferably from 23° C. to 100° C. The application temperature, i.e., the substrate temperature at which the not yet cured resin composition is applied, for example by insertion into a borehole, is typically from −10° C. to 40° C., preferably from 0° C. to 30° C., more preferably about 23° C. In a particularly preferred embodiment, it is used at a substrate temperature of 23° C. or higher, preferably of 50° C. or higher, even more preferably at a substrate temperature of 80° C. or higher, in particular at a substrate temperature of about 100° C. or higher. In this embodiment, the temperature is typically the in-service temperature, i.e., a temperature to which the resin composition is only temporarily or permanently exposed after it has cured. The temperature range from 80° C. to 120° C. is particularly preferred, even more preferred is the temperature range from 90° C. to 110° C., and in particular a substrate temperature of about 100° C. is preferred. The substrate temperature specified here is either already present when the multi-component resin is used, or is (preferably) only reached after the multi-component resin has cured. For example, the multi-component resin can be used at a substrate temperature (“application temperature”) of about 23° C., and only then are substrate temperatures (“in-service temperatures”) above 23° C., such as 80° C. to 110° C., reached.

In addition, it is typically used on or in a substrate found in buildings such as steel, concrete, wood or brick.

The invention is based on the finding that the simultaneous use of a non-cyclic aliphatic polyisocyanate (A1) with a cycloaliphatic polyisocyanate (A2) has the effect that—with approximately the same reference bond stress at 23° C.—the bond stress at higher substrate temperatures such as 100° C. is significantly increased. This is an advantage of the multi-component resin system according to the invention compared to a resin system without the addition of cycloaliphatic polyisocyanate. This is because this increased bond stress allows use (in particular as a chemical anchor) even if the resin composition prepared from the resin system is temporarily or permanently exposed to higher substrate temperatures during its application or after its curing (for example in the case of increased sun exposure or a fire).

The object of the invention is therefore also the use of an isocyanate component (A) comprising at least one non-cyclic aliphatic polyisocyanate (A1) with an average NCO functionality of about 2 or greater and at least one cycloaliphatic polyisocyanate (A2) with an average NCO functionality of about 2 or greater, in a quantitative ratio (A1:A2) (w/w) of 1:0.1 to 1:10, preferably of 1:0.5 to 1:5, more preferably of 1:0.5 to 1:1.5, in a multi-component resin system comprising an amine component (B) comprising at least one organic amine reactive towards isocyanate groups with an average NH functionality of about 2 or greater for preparing a mortar composition with increased bond stress at 80-120° C., preferably at 90-110° C., more preferably at about 100° C., as compared to a mortar composition prepared with an isocyanate component (A) which differs from the isocyanate component (A) used in that it does not comprise a cycloaliphatic polyisocyanate.

The object of the invention is therefore also the use of a cycloaliphatic polyisocyanate (A2) with an average NCO functionality of about 2 or greater, preferably of isophorone diisocyanate, for increasing the bond stress of a mortar composition at 80-120° C., more preferably at 90-110° C., more preferably at about 100° C., the mortar composition being prepared from:
(i) an isocyanate component (A) comprising at least one non-cyclic aliphatic polyisocyanate (A1) having an average NCO functionality of about 2, which is preferably a polyisocyanate based on HDI and/or PDI, and
(ii) an amine component (B) comprising at least one organic amine reactive towards isocyanate groups and having an average NH functionality of about 2 or greater,
   wherein the cycloaliphatic polyisocyanate (A2) having an average NCO functionality of about 2 or greater is used as an additional polyisocyanate in addition to the non-cyclic aliphatic polyisocyanate (A1) in the isocyanate component (A) or replaces a portion of the non-cyclic aliphatic polyisocyanate (A1) in the isocyanate component (A).

The present invention therefore uses a mixture of at least one non-cyclic aliphatic polyisocyanate and at least one cycloaliphatic polyisocyanate in component (A).

Within the context of the invention, the terms used above and in the following description have the following meanings:
“Multi-component resin system” denotes a resin system that comprises a plurality of components stored separately from one another, wherein the resin system comprises a resin component (A) and at least one curing agent component (B), so that curing takes place only after all components have been mixed. In a preferred embodiment, a multi-component resin system is a two-component resin system.
“Resin composition” denotes a reactive mass comprising a curable ingredient (in the context of the present invention: a polyisocyanate) and a suitable curing agent for the curable ingredient. According to the invention, this resin composition is typically obtained by mixing the resin component (A) (according to the invention, this is the isocyanate component) and the curing agent component (B) (according to the invention, this is the amine component) and then used as a chemical anchor or as an adhesive.
“Isocyanates” are compounds that have a functional isocyanate group —N═C═O and are characterized by the structural unit R—N═C═O.
“Polyisocyanates” are compounds that have at least two functional isocyanate groups —N═C═O; diisocyanates, which are also covered by the definition of a polyisocyanate, are characterized, for example, by the structure O═C═N—R—N═C═O and thus have an NCO functionality of 2.
“Amines” are compounds which have a functional NH group, are derived from ammonia by replacing one or two hydrogen atoms with hydrocarbon groups and have the general structures RNH₂ (primary amines) and R₂NH (secondary amines) (see: IUPAC Compendium of Chemical Terminology, 2nd ed. (the “Gold Book”), compiled by A. D. McNaught and A. Wilkinson, Blackwell Scientific Publications, Oxford (1997)).
“Average NCO functionality” describes the average number of reactive isocyanate groups per mole of a polyisocyanate or a mixture of a plurality of polyisocyanates. It is determined for a mixture according to the formula: average NCO functionality (mixture)=ΣNCO functionality (polyisocyanate i)/ni, i.e., the sum of the NCO functionality of the individual polyisocyanates i divided by the number of individual polyisocyanates i.
“NH functionality” describes the number of active hydrogen atoms that can react with an isocyanate group in an amino group.
“Average NH functionality” indicates the number of hydrogen atoms bonded to a nitrogen atom in an amine. Accordingly, for example, a primary monoamine has an average NH functionality of 2, a primary diamine has an average NH functionality of 4, an amine having 3 secondary amino groups has an average NH functionality of 3 and a diamine having one primary and one secondary amino group has an average NH functionality of 3. The average NH functionality can also be based on the information provided by the amine supplier, the NH functionality actually indicated possibly differing from the theoretical average NH functionality as it is understood here. The expression “average” means that it is the NH functionality of the compound and not the NH functionality of the amino group(s) contained in the compound. The amino groups can be primary or secondary amino groups. The amine can contain either only primary or only secondary amino groups, or both primary and secondary amino groups. The average NH functionality is determined for a mixture according to the formula: average NH functionality (mixture)=ΣNH functionality (amine j)/nj, i.e., the sum of the NH functionality of the individual amines j divided by the number of individual amines j.
“Isocyanate component (A)” or “component (A)” describes a component of the multi-component resin system which comprises at least one polyisocyanate and optionally at least one filler and/or at least one rheological additive and/or further additives. In the context of the present invention, component (A) comprises at least one non-cyclic aliphatic polyisocyanate and at least one cycloaliphatic polyisocyanate.
“Amine component (B)” or “component (B)” describes a component of the multi-component resin system which comprises at least one amine reactive towards isocyanate groups and optionally at least one filler and/or at least one rheology additive and/or further additives.
“Aliphatic compounds” are acyclic or cyclic, saturated or unsaturated, linear or branched carbon compounds, excluding aromatic compounds.
“Cycloaliphatic compounds” are aliphatic compounds comprising a carbocyclic ring structure, excluding benzene derivatives or other aromatic systems. They can carry one or more linear, branched or unbranched aliphatic substituents on the carbocyclic ring structure.
“Non-cyclic aliphatic compounds” are aliphatic compounds that do not contain a ring structure. They are therefore linear aliphatic compounds. They can be branched or unbranched and are preferably unbranched.
“Aromatic compounds” are compounds which follow Hückel's rule (4n+2).
“Araliphatic compounds” are compounds the basic structure of which has an aromatic part and an aliphatic part.
“poly”, “Poly” as a prefix means that two or more of the groups following this prefix are contained in a compound. In the context of the present invention, this means in particular that diisocyanates are included in the term “polyisocyanates”.
“Substrate temperature” denotes the temperature of the substrate at the contact surface with the resin composition to be cured or cured. The substrate temperature depends on the ambient temperature, in the construction industry typically the outside temperature, as well as possible heating due to sun exposure and external heat supply from heat sources such as a heating block or a fan heater, or from a fire. The substrate temperature can be determined using an infrared thermometer on the surface of the substrate. A distinction must be made between the substrate temperature when the not yet cured resin composition is applied (e.g., when inserting a chemical anchor into a borehole) (also referred to as the “application temperature”) and the substrate temperature after the resin composition has cured (e.g., the temperature that occurs in the substrate after curing of a chemical anchor that fixes an anchor rod in masonry due to the masonry heating up due to sun exposure) (also referred to as the “in-service temperature”).
The article “a” or “an” preceding a class of chemical compounds, e.g., preceding the word “filler,” means that one or more compounds included in this class of chemical compounds, e.g., various “fillers,” may be meant.
“At least one” means numerically “one or more”; in a preferred embodiment, this term numerically means “one”.
“About” in front of a numerical value allows for a deviation of ±10%, in a preferred embodiment ±5%, in a highly preferred embodiment ±1% from this numerical value, in the most preferred embodiment “about” means exactly this numerical value, i.e., a deviation of ±0%.
“Contain” and “comprise” mean that more constituents may be present in addition to the aforementioned constituents; these terms are meant to be inclusive and therefore also include “consist of”; “consist of” is meant conclusively and means that no further constituents may be present; in a preferred embodiment, the terms “contain” and “comprise” mean the term “consist of”.

All standards cited in this text (e.g., DIN standards) were used in the version that was current on the filing date of the present application. All trade names correspond to the products available under these trade names at the time of filing the present application.

As stated above, a multi-component resin system according to the present invention is a system which comprises two or more components stored spatially separated from one another. In a preferred embodiment, a multi-component resin system according to the invention is a two-component resin system. In the following, the constituents of the components (A) and (B) of a multi-component resin system according to the invention are explained in more detail by way of example in reference to a two-component system.

Polyisocyanate-amine systems according to the invention are multi-component systems in which one NCO group of each of the curable polyisocyanates contained in component (A) reacts with one amine group of each of the at least one amine contained in component (B). According to the invention, the isocyanate component (A) and the amine component (B) are mixed in a quantitative ratio in which the numerical relationship of average NCO functionality in the isocyanate component (A) to average NH functionality in the amine component (B) is from 0.3 to 2.0, preferably from 0.7 to 1.8, more preferably from 1.0 to 1.5, and most preferably from 1.0 to 1.3. In a particularly preferred embodiment, this numerical ratio is approximately 1.25.

### Polyisocyanates in the Isocyanate Component (A)

The isocyanate component (A) of a multi-component resin system according to the invention comprises at least one non-cyclic aliphatic polyisocyanate and at least one cycloaliphatic polyisocyanate having an average NCO functionality of about 2 or greater.

The isocyanate component (A) preferably does not comprise any aromatic polyisocyanate, i.e., the at least one non-cyclic aliphatic polyisocyanate and the at least one cycloaliphatic polyisocyanate are the only polyisocyanates in component (A).

In a preferred embodiment, the isocyanate component (A) comprises as polyisocyanates only a non-cyclic aliphatic polyisocyanate and only a cycloaliphatic polyisocyanate.

A large number of compounds known to the skilled person and commercially available for this purpose, individually or in any mixtures with one another, may be considered as the at least one non-cyclic aliphatic and at least one cycloaliphatic polyisocyanate in component (A) of the present invention.

Any polyisocyanate used according to the invention preferably has an average NCO functionality of about 2 or greater, more preferably from about 2 to about 10, even more preferably from about 2 to about 6, most preferably from about 2 to about 4.

Preferably, non-cyclic aliphatic or cycloaliphatic polyisocyanates are used which have a carbon backbone (without the contained NCO groups) of 3 to 30 carbon atoms, preferably 4 to 20 carbon atoms.

Examples of non-cyclic aliphatic polyisocyanates are bis(isocyanatoalkyl) ethers or alkane diisocyanates, such as methane diisocyanate, propane diisocyanates, butane diisocyanates, pentane diisocyanates (PDI), hexane diisocyanates (e.g., hexamethylene diisocyanate, HDI), heptane diisocyanates (e.g., 2,2-dimethylpentane-1,5-diisocyanate, octane diisocyanates, nonane diisocyanates (e.g., trimethyl-HDI (TMDI) usually as a mixture of 2,4,4- and 2,2,4-isomers), 2-methylpentane-1,5-diisocyanate (MPDI), nonane triisocyanates (e.g., 4-isocyanatomethyl-1,8-octane diisocyanate, 5-methylnonane diisocyanate), decane diisocyanates, decane triisocyanates, undecane diisocyanates, undecane triisocyanates, dodecane diisocyanates, dodecane triisocyanates.

Preferred non-cyclic aliphatic polyisocyanates are hexamethylene diisocyanate (HDI), pentane diisocyanate (PDI), trimethyl-HDI (TMDI), 2-methylpentane-1,5-diisocyanate (MPDI), and mixtures of these polyisocyanates.

Examples of cycloaliphatic polyisocyanates are 1,3- and 1,4-bis(isocyanatomethyl)cyclohexanes (H₆XDI), 3-isocyanatomethyl-3,5,5-trimethylcyclohexyl isocyanate (isophorone diisocyanate, IPDI), Bis(4-isocyanatocyclohexyl)methane (HM₁₂MD), Bis(isocyanatomethyl)norbornane (NBDI), 3(4)-isocyanatomethyl-1-methyl-cyclohexyl isocyanate (IMCI), octahydro-4,7-methano-1H-indenediemthyl diisocyanate, norbornene diisocyanate, 5-isocyanato-1-(isocyanatomethyl)-1,3,3-trimethylcyclohexane, ureylenebis(p-phenylenemethylene-p-phenylene) diisocyanate.

Preferred cycloaliphatic polyisocyanates are isophorone diisocyanate (IPDI), 1,3- and 1,4-bis(isocyanatomethyl)cyclohexane (H₆XDI), bis(isocyanatomethyl)norbornane (NBDI), 3(4)-isocyanatomethyl-1-methyl-cyclohexylisocyanate (IMCI) and 4,4′-bis(isocyanatocyclohexyl)methane (H₁₂MDI), and mixtures of these polyisocyanates.

The polyisocyanates may also be prepolymers (in particular homopolymers), biurets (in particular diisocyanate biuret oligomerization products), isocyanurates, iminooxadiazinediones, uretdiones and/or allophanates, which are based on the isocyanate compounds mentioned in the preceding paragraphs and have been prepared, for example, by reacting the isocyanate compounds mentioned in the preceding paragraphs with polyols or polyamines, individually or as a mixture. The polyisocyanates can also be mixtures of these compounds. In particular, the polyisocyanates may be prepolymers or biurets or mixtures thereof. The required average NCO functionality of about 2 or greater also exists for prepolymers, biurets, isocyanurates, iminooxadiazinediones, uretdiones and allophanates and mixtures thereof that are suitable according to the invention. The average NCO functionality here is preferably 2.5 to 5.5, more preferably 2.7 to 4, and particularly preferably 2.9 to 3.6.

Particularly preferably, said at least one non-cyclic aliphatic polyisocyanate is a polyisocyanate based on a diisocyanate, in particular a diisocyanate selected from the group consisting of hexamethylene diisocyanate (HDI), pentane diisocyanate (PDI), and mixtures of two or more thereof. Particularly preferred is the at least one non-cyclic aliphatic polyisocyanate HDI or a prepolymer (in particular a homopolymer) or biuret oligomerization product thereof, or a mixture thereof. The average NCO functionality here is preferably 2.5 to 5.5, more preferably 2.7 to 4, and particularly preferably 2.9 to 3.6. Preferred examples of this are the polyisocyanates mentioned in the examples.

Particularly preferably, the at least one cycloaliphatic polyisocyanate is a polyisocyanate based on a diisocyanate, in particular based on an isophorone diisocyanate (IPDI) or a mixture of IPDI with a non-cyclic aliphatic diisocyanate, in particular a mixture of IPDI and HDI. Particularly preferred is the at least one cycloaliphatic polyisocyanate IPDI or a prepolymer (in particular a homopolymer) thereof, or a mixture thereof with a prepolymer (in particular homopolymer) of HDI. The average NCO functionality here is preferably 2.5 to 5.5, more preferably 2.7 to 4, and particularly preferably 2.9 to 3.6. Preferred examples of this are the cycloaliphatic polyisocyanates mentioned in the examples.

Examples of suitable, commercially available polyisocyanates are Desmodur® N3900, Desmodur® N100, Desmodur® N3200, Desmodur® N3300, Desmodur® ultra N 3300, Desmodur® N3400, Desmodur® N3500, Desmodur® N3600, Desmodur® ultra N 3600, Desmodur® N 3700, Desmodur® N3800, Desmodur® eco N 7300, Desmodur® XP2675, Desmodur® 2714, Desmodur® 2731, Desmodur® N3400, Desmodur® XP2679, Desmodur® XP2731, Desmodur® XP2489, Desmodur® E 2863 XP, Desmodur® E3370, Desmodur® XP2599, Desmodur® XP2617, Desmodur® XP2406, Desmodur® XP 2838, Desmodur® XP 2840, Desmodur® NZ 300, Desmodur® E 30600, Bayhydur XP 2547, Bayhydur XP 2451/1, Bayhydur Ultra 307, Desmodur® H (each available from Covestro AG), Tolonate HDB, Tolonate HDB-LV, Tolonate HDT, Tolonate HDT-LV LM, Tolonate HDT-LV2, Tolonate XF 450, Tolonate X FLO 100, Tolonate X F 800 (available from 15 Vencorex), Basonat HB 100, Basonat HI 100 NG, Basonat HI 2000 NG, Basonat HI 100 (available from BASF), Takenate 500, Takenate 600, Stabio D-376N (available from Mitsui), Duranate 24A-100, Duranate TPA-100 (available from Asahi Kasai), Coronate HXR, Coronate HXLV, Coronate HX, Coronate HK (available from Tosoh). Of these commercially available non-cyclic aliphatic polyisocyanates and cycloaliphatic polyisocyanates, those based on HDI or IPDI (such as the polyisocyanates used in the examples) are preferred.

The ratio (A1:A2) (w/w) between at least one non-cyclic aliphatic polyisocyanate (A1) having an average NCO functionality of about 2 or greater and the at least one cycloaliphatic polyisocyanate (A2) having an average NCO functionality of about 2 or greater is advantageously from 1:0.1 to 1:10, preferably from 1:0.5 to 1:5, more preferably from 1:0.5 to 1:1.5.

The total proportion of at least one non-cyclic polyisocyanate and at least one cycloaliphatic polyisocyanate in the resin composition obtained by mixing components (A) and (B) is preferably from about 5 to about 60 wt. %, more preferably from about 10 to about 50 wt. %, and more preferably from about 15 to about 35 wt. %, and still more preferably from about 20 to about 30 wt. %, based on the total weight of the resin composition obtained by mixing components (A) and (B).

In component (A), the total proportion of at least one non-cyclic polyisocyanate and at least one cycloaliphatic polyisocyanate is preferably from about 10 to about 100 wt. %, more preferably from about 25 to about 60 wt. %, more preferably from about 30 to about 50 wt. %.

In a particularly preferred embodiment, the at least one non-cyclic aliphatic polyisocyanate and the at least one cycloaliphatic polyisocyanate are the polyisocyanates mentioned in the examples, preferably in the weight proportions mentioned therein.

### Amines in the Amine Component (B)

The amine component (B), which is present in the multi-component resin system separately from the isocyanate component (A) in a reaction-inhibiting manner, comprises at least one amine reactive towards isocyanate groups and has an average NH functionality of about 2 or greater.

The at least one amine reactive towards isocyanate groups can in principle be any amine reactive towards isocyanate groups which is known to the person skilled in the art. Thus, the at least one amine reactive towards isocyanate groups is typically a primary or secondary amine. In a preferred embodiment, at least one amine reactive towards isocyanate groups is a primary amine.

In general, mixtures of different amines may also be used.

Examples of suitable amines reactive towards isocyanate groups are given below, but without limiting the scope of the invention. These can be used either individually or in any mixtures with one another. Examples of suitable amines are: 1,2-diaminoethane(ethylenediamine), 1,2-propanediamine, 1,3-propanediamine, 1,4-diaminobutane, 2,2-dimethyl-1,3-propanediamine(neopentanediamine), diethylaminopropylamine (DEAPA), 2-methyl-1,5-diaminopentane, 1,3-diaminopentane, 2,2,4- or 2,4,4-trimethyl-1,6-diaminohexane and mixtures thereof (TMD), 1,3-bis(aminomethyl)cyclohexane, 1,2-bis(aminomethyl)cyclohexane, hexamethylenediamine (HMD), 1,2- and 1,4-diaminocyclohexane (1,2-DACH and 1,4-DACH), bis(4-amino-3-methylcyclohexyl)methane, diethylenetriamine (DETA), 4-azaheptane-1,7-diamine, 1,11-diamino-3,6,9-trioxundecane, 1,8-diamino-3,6-dioxaoctane, 1,5-diamino-methyl-3-azapentane, 1,10-diamino-4,7-dioxadecane, bis(3-aminopropyl)amine, 1,13-diamino-4,7,10-trioxatridecane, 4-aminomethyl-1,8-diaminooctane, 2-butyl-2-ethyl-1,5-diaminopentane, N,N-bis-(3-aminopropyl)methylamine, triethylenetetramine (TETA), tetraethylenepentamine (TEPA), pentaethylenehexamine (PEHA), 1,3-benzenedimethanamine (m-xylylenediamine, mXDA), 1,4-benzenedimethanamine (p-xylylenediamine, pXDA), 5-(aminomethyl)bicyclo[[2.2.1]hept-2-yl]methylamine (NBDA, norbornanediamine), dimethyldipropylenetriamine, dimethylaminopropyl-aminopropylamine (DMAPAPA), 2,4-diamino-3,5-dimethylthiotoluene (dimethylthiotoluene diamine, DMTDA) or an isomer mixture of 6-methyl-2,4-bis(methylthio)phenylene-1,3-diamine and 2-methyl-4,6-bis(methylthio)phenylene-1,3-diamine (also referred to as DMTDA, e.g. Ethacure® 300), 3-aminomethyl-3,5,5-trimethylcyclohexylamine (isophorone diamine, IPDA), diaminodicyclohexyl methane (PACM), diethyl toluene diamine (DETDA), 3,3′-diamino-diphenylsulfone (33Dapsone), 4,4′-diaminodiphenylsulfone (44Dapsone), mixed polycyclic amines (MPCA) (e.g., Ancamine® 2168), dimethyldiaminodicyclohexylmethane (e.g., Laromin® C260), 2,2-bis(4-aminocyclohexyl)propane, (3(4),8(9)bis(aminomethyldicyclo-[5.2.1.02′6]decane (isomeric mixture of tricyclic primary amines; TCD diamine), methylcyclohexyldiamine (MCDA), N,N′-diaminopropyl-2-methyl-cyclohexane-1,3-diamine, N,N′-diaminopropyl-4-methyl-cyclohexane-1,3-diamine, N-(3-aminopropyl)cyclohexylamine, 2-(2,2,6,6-tetramethylpiperidin-4-yl)propane-1,3-diamine, 2-methylpentanediamine (e.g., DYTEK® A), N-ethylaminopiperazine (N-EAP), N-aminoethyl-piperazine (N-AEP), 2,4,6-trimethyl-m-phenylenediamine, 2,4,6-tri(propan-2-yl)benzene-1,3-diamine, 4-ethyl-2,6-di(propan-2-yl)benzene-1,3-diamine, 4-methyl-2,6-di(propan-2-yl)benzene-1,3-diamine, 2,5-bis(methylsulfonyl)-1,4-benzenediamine, chlorodiethylmethyl-benzenediamines (e.g., 5-chloro-4,6-diethyl-2-methyl-1,3-benzenediamine, 5-chloro-4,6-diethyl-6-methyl-1,3-benzenediamine), 4-fluoro-5-(1-methylethyl)-1,2-benzenediamine, 4,4′-methylene-bis[N-(1-methylpropyl)phenylamine], 4,4′-methylenebis(2,6-diethylaniline) (MBDA), 4,4′-methylenebis(N-sec-butylcyclohexaneamine) (e.g., Clearlink® 1000), 4,4′-methylene-bis[N-(1-methylpropyl)-3,3′-dimethyl-cyclohexan-amine](e.g., Clearlink® 3000), 4,4′-methylene-bis(3-chloro-2,6-diethylaniline) (MBCDA), the reaction product of 2-propenenitrile with 3-amino-1,5,5-trimethyl-cyclohexanomethanamine (e.g., Jefflink® 745), 3-((3-(((2-cyanoethyl)amino)methyl)-3,5,5-trimethylcyclohexyl)amino)propiononitrile (e.g., Jefflink® 136 or Baxxodur® PC136), N,N′-di-sec-butyl-p-phenylenediamine, 2,4,6-trimethyl-m-phenylenediamine and 2,4,6-trimethyl-5-nitro-1,3-benzenediamine as well as mixtures of two or more of these amines.

Amidoamines, polyamidoamines, polyamidoimidazolines, polycycloaliphatic amines, modified amidoamines, polyamides, Mannich bases and polycarbamides are also suitable as the amine.

Examples of suitable, commercially available amines are Aradur® 1152, Aradur® 125-2, Aradur® 140-2, Aradur® 223, Aradur® 283, Aradur® 350, Aradur® 360, Aradur® 33225, Aradur® 450, Aradur® 955-2, Aradur® 3282-1, Aradur® 3376, Aradur® 9130, Aradur® 9140 (each available from Huntsman); Ancamide® 260A, Ancamide® 500, Ancamide® 503, Ancamide® 506, Ancamide® 700B75, Ancamide® 910, Ancamide® 2050, Ancamine® 2167 Ancamide® 2353, Ancamide® 2386, Ancamide® 2426, Ancamide® 2443, Ancamide® 2445, Ancamide® 2573, Ancamide® 2634, Ancamide® 2652, Ancamide® 2769, Ancamide® 3011, Ancamide® 3030, Ancamide® 3200, Ancamide® 3419, Ancamide® 3444, Ancamide® 3622, Ancamine® 2759, Ancamine® 2760, Ancamine® 3456, Ancamine® 1618, Ancamine® 1769, Ancamine® 2165, Ancamine® 2168, Ancamine® 2280, Ancamine® 2410, Ancamine® 2422, Ancamine® 2432, Ancamine® 2519, Ancamine® 2609W, Ancamine® 2672, Ancamine® 2686, Ancamine® 2692, Ancamine® 2712M, Ancamine® 2719, Ancamine® 2726, Ancamine® 2728, Ancamine® 2739, Ancamine® 2802, Ancamine® 2806, Ancamine® 3215 and Amicure® IC-322 (each available from Evonik); Baxxodur® PC136; Clearlink® 1000, Clearlink® 3000; DYTEK® A (available from Invista); Epilox® Hardener H 14-50, Epilox® Hardener H 14-51, Epilox® Hardener M 1190, Epilox® Hardener H15-15, Epilox® Hardener H15-25, Epilox® Hardener H15-40, Epilox® Hardener H15-50, Epilox® Hardener H15-60, Epilox® Hardener M1148 (each available from Leuna Harze); EPIKURE Curing Agent 3010, EPIKURE Curing Agent 3015, EPIKURE Curing Agent 3030, EPIKURE Curing Agent 3046, EPIKURE Curing Agent 3050, EPIKURE Curing Agent 3055, EPIKURE Curing Agent 3061, EPIKURE Curing Agent 3072, EPIKURE Curing Agent 3090, EPIKURE Curing Agent F205, EPIKURE Curing Agent 3100-ET-60, EPIKURE Curing Agent 3115, EPIKURE Curing Agent 3125, EPIKURE Curing Agent 3140, EPIKURE Curing Agent 3155, EPIKURE Curing Agent 3164, EPIKURE Curing Agent 3175, EPIKURE Curing Agent 3180-F-75 (each available from Westlake); Ethacure® 300, Ethacure® 100 (such as Ethacure® 100 Plus) (available from Albemarle); Jefflink® 745, Jefflink® 136; Laromin® C260 (available from BASF); Unilink® 4100, Unilink® 4200.

Particularly preferred amines are diethyl toluene diamine (DETDA, e.g., Ethacure® 100 Plus), 2,4-diamino-3,5-dimethylthiotoluene (dimethylthiotoluene diamine, DMTDA) or an isomer mixture of 6-methyl-2,4-bis(methylthio)phenylene-1,3-diamine and 2-methyl-4,6-bis(methylthio)phenylene-1,3-diamine (also referred to as DMTDA, e.g., Ethacure® 300), 4,4′-methylene-bis[N-(1-methylpropyl)phenylamine](e.g., Unilink® 4200), 4,4′-methylenebis(2,6-diethylaniline) (MBDA), 4,4′-methylenebis(N-sec-butylcyclohexanamine) (e.g., Clearlink® 1000), 3,3′-diaminodiphenylsulfone (33Dapsone), 4,4′-diaminodiphenylsulfone (44Dapsone), N,N′-di-sec-butyl-p-phenylenediamine (e.g., Unilink® 4100), 2,4,6-Trimethyl-m-phenylenediamine, 4,4′-methylene-bis[N-(1-methylpropyl)-3,3′-dimethyl-cyclohexan-amine](e.g., Clearlink® 3000), the reaction product of 2-propenenitrile with 3-amino-1,5,5-trimethylcyclohexanmethanamine (e.g., Jefflink® 745), 3-((3-(((2-cyanoethyl)amino)methyl)-3,5,5-trimethylcyclohexyl)-amino)-propiononitrile (e.g., Jefflink® 136 or Baxxodur® PC136), a mixture of DETDA and IPDA (e.g., Ethacure® 270), a mixture of 4,4′-methylenebis(N-sec-butylaniline), 4,4′-methylenebis(2,6-diethylaniline) and diethylmethylbenzenediamine (e.g., Ethacure® 520), 4,4′-methylene-bis(3-chloro-2,6-diethylaniline) (MBCDA), chlorodiethylmethylbenzenediamines (e.g., 5-chloro-4,6-diethyl-2-methyl-1,3-benzenediamine, 5-chloro-4,6-diethyl-6-methyl-1,3-benzene-diamine), Aradur® 223, Aradur® 33225, Ancamide® 506, Ancamine® 2167, Ancamide® 2426, Ancamide® 3011, Ancamide® 3419, Amicure® IC-322, Epilox® Hardener H 14-50, Epilox® Hardener H15-60, Epilox® Hardener M1148, EPIKURE Curing Agent 3050, EPIKURE Curing Agent F205, Ethacure® 300, Ethacure® 100 Plus.

Particularly preferred amines are 4,4′-methylene-bis[N-(1-methylpropyl)phenylamine], an isomer mixture of 6-methyl-2,4-bis(methylthio)phenylene-1,3-diamine and 2-methyl-4,6-bis(methylthio)phenylene-1,3-diamine (DMTDA, e.g., Ethacure® 300), diethyltoluene diamine (DETDA, e.g., Ethacure® 100 Plus), 4,4′-methylene-bis[N-(1-methylpropyl)-phenylamine](e.g., Unilink® 4200), 4,4′-methylene-bis(3-chloro-2,6-diethylaniline) (MBCDA), 4,4′-methylene-bis(2,6-diethylaniline) (MBDA), chlorodiethylmethylbenzenediamine, Aradur® 33225, Ancamide® 3419, Epilox® Hardener H 14-50. DMTDA, DETDA, and mixtures thereof are the most preferred.

Preferably, the at least one amine reactive towards isocyanate groups is selected from the group of araliphatic and aromatic amines, particularly preferably from the group of araliphatic amines. In a preferred embodiment, the amine component comprises diethyl toluene diamine (DETDA) and additionally at least one of the amines reactive towards isocyanate groups mentioned herein, preferably at least one of the aromatic amines mentioned herein.

In a particularly preferred embodiment, the amine component (B) comprises amines:
diethyl toluene diamine (DETDA), and
an isomer mixture of 6-methyl-2,4-bis(methylthio)phenylene-1,3-diamine and 2-methyl-4,6-bis(methylthio)phenylene-1,3-diamine (DMTDA).

In this preferred embodiment, the DMTDA and the DETDA are present in a quantitative ratio (DMTDA:DETDA) of about 17:1 to about 1:1 (w/w). The quantitative ratio (DMTDA:DETDA) is preferably from about 15:1 to about 1.1 (w/w), more preferably from about 12:1 to about 1.5:1 (w/w), more preferably from about 10:1 to about 1.5:1 (w/w).

Preferably, DMTDA and DETDA are the only aromatic amines in the amine component in this preferred embodiment. More preferably, DMTDA and DETDA are the only amines in the amine component.

However, in one embodiment, the amine component can also comprise at least one further amine reactive towards isocyanate groups in addition to the DMTDA and the DETDA. Preferably, this further amine has an average NH functionality of about 2 or greater. The further amine can contain either only primary or only secondary amino groups, or both primary and secondary amino groups.

If, in addition to DETDA and DMTDA, a further amine reactive towards isocyanate groups is contained in the amine component (B), its proportion of the total amount of amines in component (B) is at most about 80 wt. %, preferably at most about 50 wt. %, more preferably at most about 20 wt. %, even more preferably at most about 5 wt. % of the total amount of amines.

The total amount of amines in the resin composition obtained by mixing components (A) and (B) is preferably from about 3 to about 30 wt. %, more preferably from about 5 to about 25 wt. %, and even more preferably from about 10 to about 20 wt. %, based on the total weight of the resin composition obtained by mixing components (A) and (B).

The total amount of amines in the amine component (B) is preferably from 20 to 100 wt. %, preferably from 30 to 70 wt. %, even more preferably from 35 to 70 wt. %, and even more preferably from 40 to 60 wt. %, based on the total weight of the amine component (B).

In a particularly preferred embodiment, the at least one amine reactive towards isocyanate groups is one of the reactive amine(s) mentioned in the examples, preferably in the weight proportions mentioned therein.

### Quantitative Ratio of Isocyanate Component (A) to Amine Component (B)

The quantitative ratios of the isocyanate component (A) and the amine component (B) of the multi-component resin system are preferably selected such that the numerical ratio of average NCO functionality in the isocyanate component (A) to average NH functionality in the amine component (B) is from 0.3 to 2.0, preferably from 0.7 to 1.8, more preferably from 1.0 to 1.5, and most preferably from 1.0 to 1.3. In a particularly preferred embodiment, this numerical ratio is approximately 1.25 (for example 1.26).

By varying this quantitative ratio, the curing time, for example, can be influenced.

### Further Constituents of Components (A) and (B)

Both the isocyanate component (A) and the amine component (B) as well as both components (A) and (B) typically comprise at least one further constituent in addition to the polyisocyanates (A1) and (A2) or the at least one amine. Further typical constituents are in particular fillers, rheological additives and thickeners (thixotropic agents).

Depending on the further constituent, it may be preferred that the at least one further constituent is contained only in the component (A), only in the component (B), or in both components.

### Fillers

Both the isocyanate component (A) and the amine component (B) can contain at least one filler. It is preferred that both components, i.e., both the isocyanate component (A) and the amine component (B), each contain at least one filler.

Fillers used are preferably inorganic fillers, in particular quartz, aluminum oxides, aluminum silicates (such as zeolites), glass, corundum, porcelain, stoneware, barite, Leichtspat, gypsum, talcum, cements (such as Portland cement or aluminate cement), and/or chalk, and mixtures thereof.

The fillers can be added in the form of particles (for example in the form of powders, sands, or flours) or molded bodies (the latter preferably in the form of fibers or balls). A suitable selection of the fillers with regard to type and particle size distribution, particle size or (fiber) length can be used to control properties relevant to the application, such as rheological behavior, press-out forces, internal strength, tensile strength, pull-out forces, and impact strength.

Particularly suitable fillers are quartz powders, fine quartz powders, and ultra-fine quartz powders that have not been surface-treated, such as Millisil W3, Millisil W6, Millisil W8 and Millisil W12, preferably Millisil W12. Silanized quartz powders, fine quartz powders, and ultra-fine quartz powders can also be used. These are commercially available, for example, from the Silbond product series from the company Quarzwerke. The product series Silbond EST (modified with epoxysilane) and Silbond AST 25 (treated with aminosilane) are particularly preferred. Furthermore, it is possible for fillers based on aluminum oxide such as ultra-fine aluminum oxide fillers of the ASFP type from the company Denka, Japan (d₅₀=0.3 μm) or grades such as DAW or DAM with the type designations 45 (d₅₀<0.44 μm), 07 (d₅₀>8.4 μm), 05 (d₅₀<5.5 μm), and 03 (d₅₀<4.1 μm) to be used. Moreover, the surface-treated fine and ultra-fine fillers of the Aktisil AM 30 type (treated with aminosilane, d₅₀=2.2 μm) and Aktisil EM (treated with epoxysilane, d₅₀=2.2 μm) from Hoffman Mineral can be used. Zeolites can also be used as fillers.

The fillers can be used individually or in any mixture with one another.

The fillers and filler mixtures used in the examples are particularly preferred, in particular in the amounts and quantitative ratios described therein.

When at least one filler is present, the total filling level of a resin composition made up of components (A) and (B) is in a range from >0 to about 80 wt. %, preferably in a range from about 10 to about 70 wt. %, even more preferably in a range from about 20 to about 60 wt. %, even more preferably in a range from about 40 to about 55 wt. %. The total filling level relates to the percentage by weight of filler based on the total weight of component (A) and component (B) in the resin composition.

The proportion of fillers in the isocyanate component (A) when a filler is present therein is preferably about 20 to about 80 wt. %, preferably about 40 to about 70 wt. %, more preferably about 50 to about 65 wt. %, based on the total weight of the resin component (A). The proportion of fillers in the amine component (B), when a filler is present therein, is preferably from about 10 to about 70 wt. %., preferably from about 20 to about 60 wt. %., more preferably from about 40 to about 55 wt. %, based on the total weight of the amine component (B).

### Thickeners and Further Optional Constituents

In one embodiment, the isocyanate component (A), the amine component (B) or both components may contain at least one thickener.

Suitable thickeners are optionally organically post-treated fumed silica, bentonites, alkyl and methyl celluloses and castor oil derivatives, or mixtures of two or more thereof. Particular preference is given to organically post-treated fumed silica.

In a preferred embodiment, component (A) and/or component (B) of a multi-component resin system according to the invention comprise(s) quartz powder and/or quartz sand and silica.

Furthermore, adhesion promoters for improving the crosslinking of a substrate (for example a (bore)hole wall) can be used with an epoxy resin composition prepared from a multi-component resin system. Suitable adhesion promoters are silanes that have at least one Si-bound hydrolyzable group.

Preferred examples of adhesion promoters are 3-glycidoxypropyltrimethoxysilane, 3-glycidoxypropyltriethoxysilane, 2-(3,4-epoxycyclohexyl)ethyltrimethoxysilane, N-2-(aminoethyl)-3-aminopropylmethyl-diethoxysilane, N-2-(aminoethyl)-3-aminopropyltriethoxysilane, 3-aminopropyl-trimethoxysilane, 3-aminopropyltriethoxysilane, N-phenyl-3-aminoethyl-3-aminopropyl-trimethoxysilane, 3-mercaptopropyltrimethoxysilane and 3-mercaptopropylmethyldimethoxysilane and trimethoxysilylpropyl diethylenetetramine and mixtures thereof. Further silanes are described, for example, in EP 3 000 792 A1.

Further optional constituents are rheological additives for adjusting the flow properties. Suitable rheological additives are: phyllosilicates, such as laponites, bentonites or montmorillonite, Neuburg Siliceous Earth, fumed silica, polysaccharides, polyacrylate, polyurethane or polyurea thickeners and cellulose esters.

Wetting agents and dispersants, phlegmatizers, surface additives, plasticizers such as phthalic acid or sebacate esters, wax additives, stabilizers, antistatic agents, flexibilizers, curing catalysts, further control agents for the reaction rate, defoamers & deaerators, viscosity reducers or other process additives can also be added for optimization.

Likewise conceivable are coloring additives such as dyes or pigments, for example for different coloring of the components for better control of their mixing.

### Use

The multi-component resin system according to the invention is particularly suitable as a chemical anchor for the chemical fastening of components, such as threaded anchor rods, rebars, threaded sleeves, and screws in depressions, in particular (bore)holes and gaps, which are introduced into substrates typically used in construction. In addition, the multi-component resin system according to the invention is also suitable as an adhesive.

During use, the resin component (A) and the amine component (B) are mixed in a suitable device, for example a static mixer or a dissolver, resulting in a resin composition.

When used as a “chemical anchor” for chemical fastening, mixing is carried out directly in front of or in a hole (preferably a borehole) or gap, and the resulting resin composition is then introduced into the (possibly previously cleaned) hole or gap by means of a known injection device. Subsequently, the component to be fixed is inserted into the resin composition, which is preferably a mortar composition here, and adjusted. The composition then cures.

When used as an adhesive, the resin composition is mixed in a suitable manner (static mixer, manual stirring) and then applied to the parts to be bonded.

The amines of the amine component (B) react with the isocyanate groups of the resin component (A) so that the resin composition cures within a desired time under ambient conditions, for example at the construction site. This chemical reaction depends on the temperature and the humidity of the environment and the substrate, the chemical composition of the substrate and the constituents of components (A) and (B) used. Ambient conditions may vary, such as high temperatures (e. g., 40° C. or higher) in direct strong sunlight or in the event of a fire.

A multi-component resin system according to the invention is preferably used for construction purposes. The term “for construction purposes” means the construction bonding and the use of the multi-component resin system as a chemical anchor.

The multi-component resin system is used in particular on or in brick, concrete, stone or other mineral substrates, steel or wood. In a particularly preferred embodiment, it is used on or in concrete as a substrate.

The multi-component resin system is used as an adhesive (in construction bonding) in particular for bonding and for the structural reinforcement of components made of wood, masonry and other mineral materials, for the reinforcement of building objects with fiber-reinforced polymers, for chemical fastening on surfaces made of brick, concrete, stone, wood, steel or other mineral materials.

The multi-component resin system is used as a chemical anchor in particular for the chemical fastening of construction elements and anchoring means, such as (threaded) anchor rods, anchor bolts, (threaded) rods, (threaded) sleeves, rebars, screws and the like, in (bore)holes or gaps in different substrates, such as masonry, concrete, brick, other mineral materials, metals (e.g., steel), ceramics, plastics, glass and wood.

A multi-component resin system according to the invention is very particularly preferably used for the chemical fastening of anchoring elements in a hole (in particular a borehole) or gap in a building substrate. The construction substrate is preferably concrete.

It is typically used at a substrate temperature of −10° C. to 120° C., preferably from 0° C. to 110° C., more preferably from 10° C. to 105° C., even more preferably from 23° C. to 100° C. The application temperature, i.e., the substrate temperature at which the not yet cured resin composition is applied, for example by insertion into a borehole, is typically from −10° C. to 40° C., preferably from 0° C. to 30° C., more preferably about 23° C. In a particularly preferred embodiment, it is used at a substrate temperature of 23° C. or higher, preferably of 50° C. or higher, even more preferably at a substrate temperature of 80° C. or higher, in particular at a substrate temperature of about 100° C. or higher. In this embodiment, the temperature is typically the in-service temperature, i.e., a temperature to which the resin composition is only temporarily or permanently exposed after it has cured. The temperature range from 80° C. to 120° C. is particularly preferred, even more preferred is the temperature range from 90° C. to 110° C., and in particular a substrate temperature of about 100° C. is preferred. The substrate temperature specified here is either already present when the multi-component resin is used, or is (preferably) only reached after the multi-component resin has cured. For example, the multi-component resin can be used at a substrate temperature (“application temperature”) of about 23° C., and only then are substrate temperatures (“in-service temperatures”) above 23° C., such as 80° C. to 110° C., reached.

For use as chemical anchors in the construction sector, in particular in the case of large components, the substrate temperature typically depends on the ambient temperature.

In addition, chemical anchors are typically used on a substrate found in buildings such as steel, concrete, wood, stone or brick. The substrate is preferably concrete, for example the concrete used in the examples.

As already explained above, the invention is based on the finding that the simultaneous use of a non-cyclic aliphatic polyisocyanate (A1) with a cycloaliphatic polyisocyanate (A2) has the effect that—with approximately the same reference bond stress at 23° C.—the bond stress is significantly increased at higher substrate temperatures such as 100° C. This is an advantage of the multi-component resin system according to the invention compared to a resin system without the addition of cycloaliphatic polyisocyanate. This is because this increased bond stress allows use (in particular as a chemical anchor) even if the resin composition prepared from the resin system is temporarily or permanently exposed to higher substrate temperatures during its application or after its curing (for example in the case of increased sun exposure or a fire).

The object of the invention is therefore also the use of an isocyanate component (A) comprising at least one non-cyclic aliphatic polyisocyanate (A1) with an average NCO functionality of about 2 or greater and at least one cycloaliphatic polyisocyanate (A2) with an average NCO functionality of about 2 or greater, in a quantitative ratio (A1:A2) (w/w) of 1:0.1 to 1:10, preferably of 1:0.5 to 1:5, more preferably of 1:0.5 to 1:1.5, in a multi-component resin system comprising an amine component (B) comprising at least one organic amine reactive towards isocyanate groups with an average NH functionality of about 2 or greater for preparing a mortar composition with increased bond stress at 80-120° C., preferably at 90-110° C., more preferably at about 100° C., as compared to a mortar composition prepared with an isocyanate component (A) which differs from the isocyanate component (A) used in that it does not comprise a cycloaliphatic polyisocyanate.

The object of the invention is therefore also the use of a cycloaliphatic polyisocyanate (A2) with an average NCO functionality of about 2 or greater, preferably of isophorone diisocyanate, for increasing the bond stress of a mortar composition at 80-120° C., more preferably at 90-110° C., more preferably at about 100° C., the mortar composition being prepared from:
(i) an isocyanate component (A) comprising at least one non-cyclic aliphatic polyisocyanate (A1) having an average NCO functionality of about 2, which is preferably a polyisocyanate based on HDI and/or PDI, and
(ii) an amine component (B) comprising at least one organic amine reactive towards isocyanate groups and having an average NH functionality of about 2 or greater,
   wherein the cycloaliphatic polyisocyanate (A2) having an average NCO functionality of about 2 or greater is used as an additional polyisocyanate in addition to the non-cyclic aliphatic polyisocyanate (A1) in the isocyanate component (A) or replaces a portion of the aliphatic polyisocyanate (A1) in the isocyanate component (A).

In the latter multi-component resin system, a portion of the non-cyclic aliphatic polyisocyanate (A1) is replaced by the cycloaliphatic polyisocyanate. This replacement of a “portion” here preferably means that so much non-cyclic aliphatic polyisocyanate (A1) is replaced by cycloaliphatic polyisocyanate (A2) that a ratio (A1:A2) as described above is achieved.

### PREFERRED EMBODIMENTS

### Component (A):

In a preferred embodiment, component (A) of a multi-component resin system according to the invention comprises HMDI or a prepolymer or biuret thereof as polyisocyanate (A1), isophorone diisocyanate (IPDI) or a prepolymer or biuret thereof as polyisocyanate (A2), at least one filler, at least one thickener, and at least one rheology additive.

In a more preferred embodiment, component (A) of a multi-component resin system according to the invention comprises HMDI homopolymer as polyisocyanate (A1) and IPDI homopolymer as polyisocyanate (A2), quartz flour and/or quartz sand, zeolite, silica and a silane.

The ratio (A1:A2) (w/w) is advantageously from 1:0.1 to 1:10, preferably from 1:0.5 to 1:5, more preferably from 1:0.5 to 1:1.5.

In a particularly preferred embodiment, component (A) of a multi-component resin system according to the invention comprises from about 13 to about 26 wt. % of HMDI homopolymer and from about 1 to about 15 wt. % of IPDI homopolymer, from about 30 wt. % to about 50 wt. % of quartz flour and/or quartz sand, from about 2 to about 3 wt. % of zeolite, from about 0.5 to about 1.5 wt. % of silica, and from about 1 to about 2.5 wt. % of silane, with all wt. % being based on the total weight of the resin composition obtained by mixing components (A) and (B). In this particularly preferred embodiment, the ratio (A1:A2) (w/w) is from 1:0.5 to 1:5, more preferably from 1:0.5 to 1:1.5.

Particularly preferably, component (A) comprises the isocyanate combination as described in the examples, and additionally preferably at least one filler.

Most preferably, component (A) is the component (A) described in the example.

### Component (B):

In a preferred embodiment, component (B) of a multi-component resin system according to the invention comprises DMTDA and DETDA as the only amines, at least one filler and silica.

In this preferred embodiment, the DMTDA and the DETDA are present in a quantitative ratio (DMTDA:DETDA) of about 10:1 to about 1.5:1 (w/w).

In a highly preferred embodiment, component (B) of a multi-component resin system according to the invention comprises from about 5 to about 25 wt. %, more preferably from about 10 to about 15 wt. %, of DMTDA plus DETDA, from about 8 to about 20 wt. % of quartz powder and/or quartz sand, and from about 0.2 to about 0.9 wt. % of silica, with all wt. % being based on the total weight of the resin composition obtained by mixing components (A) and (B). In this embodiment, the DMTDA and the DETDA are present in a quantitative ratio (DMTDA:DETDA) of about 10:1 to about 1.5:1 (w/w).

Particularly preferably, component (B) comprises the DMTDA-DETDA combination as described in the examples as the only amines, and additionally preferably at least one filler.

Most preferably, component (B) is the component (B) described in the examples.

### Components A+B

Very particularly preferred as constituents of a multi-component resin system according to the invention are the combinations of the polyisocyanates with DMTDA and DETDA (as the only amines in the resin system), which are used in the example compositions, in particular in the weight proportions used there and very particularly preferably in combination with the other constituents of components (A) and (B) used there. Most preferred for a multi-component resin system according to the invention consisting of components (A) and (B) are those compositions of components (A) and (B) which are described as combinations in the examples.

The isocyanate component (A) and the amine component (B) are mixed in a quantitative ratio in which the numerical relationship of average NCO functionality in the isocyanate component (A) to average NH functionality in the amine component (B) is from 1.0 to 1.5, and preferably from 1.0 to 1.3. In a particularly preferred embodiment, this numerical ratio is about 1.25, in particular about 1.26.

In a particularly preferred embodiment of a multi-component resin system according to the invention, component (A) comprises from about 13 to about 26 wt. % of HMDI homopolymer as polyisocyanate (A1) and from about 1 to about 15 wt. % of IPDI homopolymer as polyisocyanate (A2), from about 30 wt. % to about 50 wt. % of quartz flour and/or quartz sand, from about 2 to about 3 wt. % of zeolite, from about 0.5 to about 1.5 wt. % of silica, and from about 1 to about 2.5 wt. % of silane, with all wt. % being based on the total weight of the resin composition obtained by mixing components (A) and (B), and wherein the ratio (A1:A2) (w/w) is from 1:0.5 to 1:5, more preferably from 1:0.5 to 1:1.5; and component (B) is from about 5 to about 25 wt. %, more preferably from about 10 to about 20 wt. %, of DMTDA plus DETDA, from about 8 to about 15 wt. % of quartz flour and/or quartz sand, and from about 0.2 to about 0.9 wt. % of silica, with all wt. % being based on the total weight of the resin composition obtained by mixing components (A) and (B), and wherein the DMTDA and the DETDA are present in a quantitative ratio (DMTDA:DETDA) of from about 10:1 to about 1.5:1 (w/w). Here, the isocyanate component (A) and the amine component (B) are mixed in a quantitative ratio in which the numerical relationship of average NCO functionality in the isocyanate component (A) to average NH functionality in the amine component (B) is from 1.0 to 1.3. Particularly preferably, this numerical ratio is about 1.25 (for example 1.26). The combination of component (A) and (B) described in the example is the most preferred.

The invention is described in greater detail below in reference to embodiments which, however, should not be understood in a restrictive sense.

### EXEMPLARY EMBODIMENTS

TABLE 1
Used constituents of components (A) and (B)

| | | |
|---|---|---|
| Hexamethylene-1,6-diisocyanate | Desmodur ® N 3900: | Covestro AG |
| homopolymer | low-viscosity, aliphatic | |
| | polyisocyanate resin based on | |
| | hexamethylene diisocyanate | |
| | (HDI) (equivalent weight | |
| | approx. 179; NCO content | |
| | according to M105-ISO 11909 | |
| | 23.5 +− 0.5 wt. %, | |
| | monomeric HDI according to | |
| | M106-ISO 10283 <0.25%; | |
| | viscosity (23° C.) according to | |
| | M014-ISO 3219/A.3 | |
| | 730 +− 100 mPa · s) | |
| Hexamethylene-1,6-diisocyanate | Desmodur ® N 3200 | Covestro AG |
| biuret oligomerization product | | |
| Mixture of hexamethylene-1,6- | Desmodur ® XP 2838 | Covestro AG |
| diisocyanate homopolymer and | | |
| isophorone diisocyanate | | |
| homopolymer | | |
| Mixture of 6-methyl-2,4- | Ethacure ® 300 Curative | Albemarle |
| bis(methylthio)phenylene-1,3- | (dimethylthiotoluene diamine 95- | Corporation |
| diamine and 2-methyl-4,6- | 97%, monomethylthiotoluene | |
| bis(methylthio)phenylene-1,3- | diamine 2-3%; equivalent weight | |
| diamine (DMTDA) | with isocyanates 107) | |
| Diethyl toluene diamine (DETDA) | Ethacure ® 100 Plus | Albemarle |
| | | Corporation |
| 3- | Dynasylan ® GLYMO | Evonik |
| Glycidyloxypropyltrimethoxysilane | | Resource |
| | | Efficiency |
| | | GmbH |
| Zeolite powder | Synthetic zeolite; Purmol ® 3ST | Zeochem AG |
| Quartz powder | Millisil ® W12 | Quarzwerke |
| | | Frechen |
| Quartz sand | P10 | Strobel |
| Silica | Cab-O-Sil ® TS-720 | Cabot |

### Preparation of Components (A) and (B)

The used constituents of all (comparative) examples and their proportions in wt. %, based on the total weight of component (A) plus (B), are listed below in Table 2.

Both component (A) and component (B) were prepared by means of a dissolver (PC Laborsystem, volume 1 L). After the fillers were added to the liquid constituents of the respective components, which were in a beaker or plastic bucket suitable for the dissolver, the component was first mixed by hand with a wooden spatula. The plastic bucket or the beaker were then attached to the disc stirrer, the cover was closed and a vacuum of 80 mbar was produced in order to prevent the introduction of air inclusions into the composition. The stirring process ran at 2,500 rpm for eight minutes.

The compounds prepared in this way were then filled into 3:1 2-component hard cartridges (2K cartridges) using a static mixer without air bubbles.

### Determination of the Bond Stress:

To determine the bond stress achieved with the mortar compositions prepared from components (A) and (B), a high-strength threaded anchor rod M12 was used, which was inserted into a hammer-drilled borehole having a diameter of 14 mm and a borehole depth of 60 mm containing the corresponding mortar composition in C20/25 concrete slabs. For the insertion, the bottom two-thirds of the borehole were filled with the corresponding mortar composition to be tested from the 2K cartridge, using a static mixer.

To determine the reference bond stress, after a curing time of 24 hours at a temperature of 23° C., the bond stress was determined by centrically pulling out the threaded anchor rod with close support (i.e., support close to the borehole).

To determine the bond stress at 100° C., after a curing time of 24 hours at a temperature of 23° C., the concrete slab was heated to 100° C. and kept at this temperature for 24 hours. Immediately after removing the concrete slab from the oven, the bond stress was determined at 100° C. by centrically pulling out the threaded anchor rod with close support.

TABLE 2
Composition of example and comparative example and test results (composition
in wt. % based on the mixture of (A) and (B) used; where the sum of
these wt. % is not exactly 100%, this is due to rounding errors)

| Constituents | V1* | A1 |
|---|---|---|
| Component (A) | | |
| Hexamethylene-1,6-diisocyanate homopolymer (N3900) | 21.7 | 13.3 |
| Hexamethylene-1,6-diisocyanate biuret oligomerization | 3.5 | — |
| product (N3200) | | |
| Mixture of hexamethylene-1,6-diisocyanate homopolymer | — | 13.3 |
| and isophorone diisocyanate homopolymer (XP2838) | | |
| 3-Glycidyloxypropyltrimethoxysilane | 1.7 | 1.7 |
| Quartz powder (W12) | 15.5 | 13.9 |
| Quartz sand | 31.8 | 31.9 |
| Silica | 0.9 | 0.8 |
| Zeolite powder | 2.3 | 2.3 |
| Component (B) | | |
| (6-Methyl-2,4-bis(methylthio)phenylene-1,3-diamine/2- | 11.0 | 11.1 |
| methyl-4,6-bis(methylthio)phenylene-1,3-diamine (DMTDA) | | |
| Diethyl toluene diamine (DETDA) | 1.1 | 1.1 |
| Quartz powder | 2.3 | 2.3 |
| Quartz sand | 7.8 | 7.9 |
| Silica | 0.4 | 0.4 |
| Stoichiometry of isocyanate groups:amine groups | 1.26:1 | 1.26:1 |
| (determined using equivalent weights) | | |
| Bond stress at 23° C. in N/mm² | 32.9 | 31.6 |
| Bond stress at 100° C. in N/mm² | 20.9 | 24.1 |

Table 2 shows that in comparative example V1, the bond stress drops significantly when the temperature is increased from 23° C. to 100° C. By adding the HDI/IPDI mixture (XP2838)—with approximately the same reference bond stress at 23° C.—the bond stress at 100° C. can be significantly increased.

1. A multi-component resin system, comprising:
a) an isocyanate component (A), and
b) an amine component (B) comprising at least one organic amine reactive towards isocyanate groups and having an average NH functionality of about 2 or greater,
wherein the isocyanate component (A) comprises at least one non-cyclic aliphatic polyisocyanate (A1) having an average NCO functionality of about 2 or greater and at least one cycloaliphatic polyisocyanate (A2) having an average NCO functionality of about 2 or greater in a ratio (A1:A2) (w/w) of from 1:0.1 to 1:10.

2. The multi-component resin system according to claim 1, wherein the isocyanate component (A) and the amine component (B) are present in a quantitative ratio in which a numerical ratio of average NCO functionality in the isocyanate component (A) to average NH functionality in the amine component (B) is from 0.3 to 2.0.

3. The multi-component resin system according to claim 1, wherein the at least one non-cyclic aliphatic polyisocyanate (A1) is a non-cyclic aliphatic polyisocyanate based on a non-cyclic aliphatic isocyanate having a carbon backbone with 3 to 30 carbon atoms.

4. The multi-component resin system according to claim 1, wherein the at least one cycloaliphatic polyisocyanate (A2) is a cycloaliphatic polyisocyanate based on a cycloaliphatic isocyanate having a carbon backbone with 3 to 30 carbon atoms.

5. The multi-component resin system according to claim 1, wherein the at least one non-cyclic aliphatic polyisocyanate (A1) is an aliphatic polyisocyanate based on an isocyanate selected from the group consisting of hexamethylene diisocyanate (HDI), trimethyl hexamethylene diisocyanate (TMDI), pentane diisocyanate (PDI), and mixtures of two or more thereof.

6. The multi-component resin system according to claim 1, wherein the at least one cycloaliphatic polyisocyanate (A2) is a cycloaliphatic polyisocyanate based on an isocyanate selected from the group consisting of 4-bis-(isocyanatomethyl)cyclohexane (H₆XDI), 3-isocyanatomethyl-3,5,5-trimethylcyclohexyl isocyanate (isophorone diisocyanate, IPDI), bis-(4-isocyanatocyclohexyl)methane (H₁₂MDI), 3(4)-isocyanatomethyl-1-methyl-cyclohexyl isocyanate (IMCI), 5-isocyanato-1-(isocyanatomethyl)-1,3,3-trimethylcyclohexane, bis(isocyanatomethyl)norbornane (NBDI), and mixtures of two or more thereof.

7. The multi-component resin system according to claim 1, wherein the at least one non-cyclic aliphatic polyisocyanate (A1) is an HDI homopolymer, and wherein the at least one cycloaliphatic polyisocyanate (A2) is an IPDI homopolymer.

8. The multi-component resin system according to claim 1, wherein the at least one organic amine reactive towards isocyanate groups is selected from the group consisting of aliphatic amines, cycloaliphatic amines, araliphatic amines, aromatic amines, and mixtures of two or more thereof.

9. The multi-component resin system according to claim 1, wherein the at least one organic amine reactive towards isocyanate groups is selected from the group consisting of an isomer mixture of (6-methyl-2,4-bis(methylthio)phenylene-1,3-diamine and 2-methyl-4,6-bis(methylthio)-phenylene-1,3-diamine (DMTDA), DETDA, and mixtures thereof.

10. The multi-component resin system according to claim 1, the isocyanate component (A) and/or the amine component (B) further comprising:
at least one filler.

11. The multi-component resin system according to claim 1, wherein the multi-component resin system is a two-component resin system.

12. A mortar composition prepared by mixing the isocyanate component (A) and the amine component (B) of the multi-component resin system according to claim 1.

13. A process for chemical fastening of construction elements in boreholes or gaps in buildings, the process comprising:
applying the mortar composition according to claim 12 in boreholes or gaps in buildings.

14. The mortar composition according to claim 12,
which has an increased bond stress at 80-120° C., compared to a mortar composition prepared with an isocyanate component which differs from said isocyanate component (A) in that it does not comprise a cycloaliphatic polyisocyanate.

15. A process for increasing the bond stress of a mortar composition at 80-120° C., the process comprising:
adding a cycloaliphatic polyisocyanate (A2) a having an average NCO functionality of about 2 or greater to a mortar composition which is more prepared from:
(i) an isocyanate component (A) comprising at least one non-cyclic aliphatic polyisocyanate (A1) having an average NCO functionality of about 2, and
(ii) an amine component (B) comprising at least one organic amine reactive towards isocyanate groups and having an average NH functionality of about 2 or greater,
wherein the cycloaliphatic polyisocyanate (A2) having an average NCO functionality of about 2 or greater is as an additional polyisocyanate in addition to the non-cyclic aliphatic polyisocyanate (A1) in the isocyanate component (A) or replaces a portion of the non-cyclic aliphatic polyisocyanate (A1) in the isocyanate component (A).
